(19) United States
(12) Patent Application Publication
(10) Pub. No.: US 2026/0259361 A1
(43) Pub. Date: Sep. 3, 2026

(54) LIGHTING MODULE COMPRISING A PLURALITY OF FLEXIBLE GUIDE SHEETS

(71) Applicant: VALEO VISION, Bobigny (FR)

(72) Inventors: Sid Ahmed BEDDAR, Bobigny (FR); Eduardo ALVEAR CABEZON, Bobigny (FR); Hafid EL IDRISSI, Bobigny (FR); Benoit DELANDE, Bobigny (FR)

(73) Assignee: VALEO VISION, Bobigny (FR)

(21) Appl. No.: 18/867,217

(22) PCT Filed: May 17, 2023
(86) PCT No.: PCT/EP2023/063203

§ 371 Date: Nov. 19, 2024

(30) Foreign Application Priority Data
May 30, 2022 (FR) FR2205159

(51) Int. Cl. F21V 8/00

(52) U.S. Cl. CPC G02B 6/0023; G02B 6/0061; G02B 6/0076

(57) ABSTRACT

The invention relates to a luminous module including at least two flexible guide sheets, each sheet being able to reflect rays of light according to an etched pattern. A first light-injection element is able to distribute light in the first sheet and a second light-injection element is able to distribute the light in the second sheet. The first sheet and the second sheet are arranged one beside the other in such a way that a second edge of the first flexible guide sheet faces a second edge of the second flexible guide sheet. A part of the first sheet along the second edge and a part of the second sheet along the second edge are bent toward the inside of the luminous module or are covered with a reflective material.

### TECHNICAL FIELD

The present invention relates to the field of luminous modules, notably light guide luminous modules. The invention applies in particular, although not exclusively, to the display of luminous patterns.

### BACKGROUND OF THE INVENTION

There is now a need to display luminous patterns on numerous pieces of equipment, for the purposes of signaling information, for esthetic customization purposes, or to create an ambience.

In order to do this, it is known practice to use screens, such as LCD screens.

However, such technology is not only expensive but also sensitive to the environmental conditions such as temperature, moisture or UV radiation.

What is more, it is preferable to have a luminous module that is flexible so that it can be integrated more easily into any type of equipment.

There is therefore a need to have a luminous module capable of creating an animation, and that is robust, inexpensive and easy to integrate into any type of equipment.

The international patent application published under number WO2011130715A2 proposes a flexible guide sheet able to return the light injected by an injection strip from a light source, according to a given pattern.

However, the size of such a flexible guide sheet is limited by constraints associated with its manufacture. Thus, obtaining luminous modules of large size based on this technology imposes the need to use at least two flexible guide sheets placed one beside the other.

However, this technology has the disadvantage that the edges of a flexible guide sheet into which the light is injected appear as luminous. Thus, if two flexible guide sheets are placed one beside the other in order to create a luminous module of larger size, their junction appears as luminous and this introduces an undesired defect into the patterns projected. In particular, if a shape or symbol is projected made up of the two complementing patterns of the two guide sheets, a luminous strip will impair the visual appearance of such a shape or symbol.

### SUMMARY OF THE INVENTION

The present invention improves the situation.

To this end, a first aspect relates to a luminous module comprising:
an assembly of at least two flexible guide sheets, comprising a first flexible guide sheet and a second flexible guide sheet, each flexible guide sheet of the assembly being able to receive rays of light via at least a first edge of said flexible guide sheet and to reflect the rays of light in a direction substantially normal to a surface of the flexible guide sheet according to at least one pattern etched in said flexible guide sheet;
at least a first light-injection element able to receive light and to distribute the light in the first flexible guide sheet and a second light-injection element able to receive light and to distribute the light in the second flexible guide sheet;
at least one light source able to inject light into the first light-injection element and into the second light-injection element.

The first flexible guide sheet and the second flexible guide sheet are arranged one beside the other in such a way that a second edge of the first flexible guide sheet faces a second edge of the second flexible guide sheet. The first flexible guide sheet and the second flexible guide sheet delimit an outer half-space toward which the light rays are emitted in the direction substantially normal to the surface of the flexible guide sheets, and an inner half-space of the luminous module, complementing the outer half-space. Part of the first flexible guide sheet extending along the second edge, and part of the second flexible guide sheet extending along the second edge, are bent toward the inner half-space or are at least partially covered with a reflective material.

Thus, luminous modules with a large light-emitting surface can be created, making it possible to create complex and large-sized patterns. The junction between two flexible guide sheets does not experience unwanted illumination because of the bending of the second edges of the flexible guide sheets toward the inside of the module, according to a first embodiment, or because of a reflective material arranged at the junction, according to a second embodiment.

According to the first embodiment, the luminous module further comprises a support arranged in the inner half-space and able to hold the assembly of at least two flexible guide sheets, the support comprising a cavity able to accommodate the bent part of the first flexible guide sheet and the bent part of the second flexible guide sheet.

Thus, a module is easier to integrate into an item of equipment, such as an item of automotive vehicle equipment.

According to the first embodiment, the part of the first flexible guide sheet extending along the second edge and the part of the second flexible guide sheet extending along the second edge are bent toward the inner half-space and the reflective material at least partially covers a surface of the bent parts that faces toward the inner half-space.

Thus, it becomes possible to improve the light output of the luminous module according to the first embodiment, because the light that reaches the surface facing toward the inner half-space is reflected into the flexible guide sheet so that it can be emitted toward the outer half-space according to the pattern. Furthermore, because the reflective material faces toward the inner half-space, it does not degrade the luminous patterns projected by the flexible guide sheets.

As an alternative, according to the second embodiment, the reflective material at least partially covers a surface facing toward the outer half-space of the part of the first flexible guide sheet extending along the second edge and of the part of the second flexible guide sheet extending along the second edge.

Thus, there is no need to bend the parts of the flexible guide sheets extending along the second edge, thereby making the luminous module easier to manufacture while still preventing light from being emitted along the second edge.

Depending on the embodiment, the reflective material may be a reflective paint.

Thus, the visual appearance of the projected patterns is improved without adding an additional component and while creating the minimum of additional bulk.

According to the first embodiment or the second embodiment, the reflective material may be a strip extending along the second edges of the first and second flexible guide sheets.

Thus, the junction between the flexible guide sheets is completely covered by the reflective material, thereby improving the visual appearance of the patterns projected by the luminous module in the second embodiment and improving the light output in the first embodiment.

Depending on the embodiment, the first flexible guide sheet may be etched in such a way as to project a first pattern when said at least one light source injects light into the first injection element, and the second flexible guide sheet may be etched in such a way as to project a second pattern when said at least one light source injects light into the second injection element, the first and second patterns arranged one beside the other being able together to form at least one luminous symbol.

The invention is particularly advantageous in instances in which such a luminous signal is created from several patterns or several flexible guide sheets. Without the invention, such a symbol would have had a luminous strip running through it at the junction between the flexible guide sheets.

In addition, the strip of reflective material may be interrupted over the luminous symbol.

Thus, the projection of the patterns which forms a luminous symbol is optimized, without being degraded by the junction between several flexible guide sheets. The light output associated with the luminous module is also improved.

According to the first embodiment or the second embodiment, at least one of the flexible guide sheets may further comprise a third edge distinct from the first and second edges, wherein at least part of the flexible guide sheet extending along the third edge is covered with a reflective material on a surface facing toward the outer half-space.

Edge effects are thus avoided on the edge or edges of a flexible guide sheet that does or do not form a junction with another flexible guide sheet.

Depending on the embodiment, the light source may be able selectively to inject light into a first optical fiber connected to the first injection element and into a second optical fiber connected to the second injection element.

A single light source can thus be situated remotely in relation to the flexible guide sheets and to the injection elements, thereby making the luminous module easier to integrate, notably into equipment where there are considerable constraints on space.

Depending on the embodiment, the assembly may comprise more than two flexible guide sheets placed one beside the other in such a way as to form an array of flexible guide sheets.

Thus, it becomes possible to create large-sized luminous modules with complex patterns.

Depending on the embodiment, one dimension of the flexible guide sheets may be comprised between 3 and 25 cm.

Thus, it becomes possible to create a large-sized luminous modules.

Depending on the embodiment, each flexible guide sheet of the assembly may have a thickness comprised between 0.2 and 1 mm.

Thus, the guide sheets offer considerable flexibility, making them easier to integrate.

Depending on the embodiment, each flexible guide sheet may comprise a film comprising microstructures, each pattern from among the first and second patterns being able to be etched by ultraviolet printing of the microstructures of the film.

Such microstructures make it possible to maintain a high level of transparency of the flexible guide sheet while projecting light in the luminous zone when the light source is activated.

In addition to this, for each flexible guide sheet, the surface density of microstructures may decrease with distance from the edge of the guide sheet into which the light is injected.

The homogeneity of a pattern projected by the flexible guide sheet is thus improved.

### BRIEF DESCRIPTION OF DRAWINGS

Further features and advantages of the invention will become apparent on reading the detailed description below and on studying the appended drawings, in which:

FIG. 1 illustrates part of a luminous module according to the invention;

FIG. 2 illustrates an injection element of a luminous module according to one embodiment of the invention;

FIG. 3 illustrates a luminous module according to the invention;

FIG. 4 illustrates a luminous module according to a first embodiment of the invention; and

FIG. 5 illustrates a luminous module according to a second embodiment of the invention.

### DETAILED DESCRIPTION OF THE INVENTION

The description concentrates on those features that differentiate the luminous module from those known in the prior art.

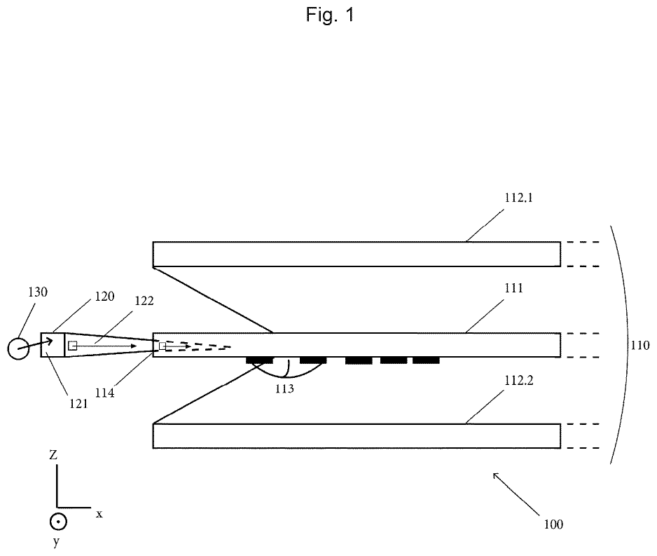

FIG. 1 shows part of a luminous module 100 according to the invention.

The luminous module 100 comprises a flexible guide sheet 110 able to receive rays of light via at least a first edge 114 and to reflect the rays of light in a direction Z substantially normal to a surface of the flexible guide sheet which thus extends in a plane X-Y in FIG. 1.

What is meant by a guide sheet is an optical-guide element of which one of the dimensions is very much smaller than the other two dimensions in space, for example one or more orders of magnitude smaller. As illustrated in FIG. 1, what is considered here is a flexible guide sheet of which the thickness along the axis Z is at least two orders of magnitude smaller than its dimensions in the plane X-Y in which the flexible guide sheet 110 extends.

The flexible guide sheet 110 may comprise a flexible film 111 at its core comprising at least a first edge 114 able to guide the rays of light in an overall direction X, and comprising a collection of microstructures 113 able to reflect the rays of light guided in the flexible film 111 out of the flexible guide sheet 110, notably in one or more directions substantially along the axis Z.

The flexible film 111 may be a film of substrate made of polycarbonate PC, polymethyl methacrylate PMMA, thermoplastic polyurethane TPU or polyethylene terephthalate PET. The flexible film 111 may have a thickness, namely a dimension along the axis Z, comprised between 12 and 1000 micrometers. More specifically, the thickness of the flexible film 111 may be comprised between 50 and 1000 micrometers, for example between 200 and 500 micrometers. As an alternative, it is the flexible guide sheet 110 that has a thickness comprised between 200 and 1000 micrometers.

The aforementioned materials, combined with a small thickness as described hereinabove, make it possible to obtain a flexible film 111. Other materials may be conceived of for the composition of the flexible film 111. However, it is preferable according to the invention to conceive of materials that are deformable and transparent.

A fine coating of microstructures 113 may be applied to one of the faces of the flexible film 111, or integrated into the flexible film 111. The coating of microstructures 113 may notably have a thickness along the axis Z less than 20 micrometers.

Such microstructures 113 may have the overall shape of a bump, off which the rays of light reflect in a direction substantially along the axis Z. Such microstructures 113 may be able to ensure that the rays of light leaving the flexible film 111 form a pattern. Specifically, the microstructures 113 may be etched according to the desired pattern using ultraviolet printing.

What is meant by microstructures 113 is structures, or irregularities of the flexible film, of which the dimensions are less than a few micrometers. The microstructures thus also cover nanometer-scale structures. Such sizes of microstructures 113 make it possible to ensure that the flexible film 111 has a high degree of transparency. In particular, a transparency of the order of 97% may be obtained in practice through the use of microstructures 113. As an alternative, the flexible guide sheet may be semi-transparent or opaque.

Advantageously, the microstructures 113 may be distributed along the axis X in such a way that the linear density of microstructures 113 is proportional to the distance away from the first edge 114 via which the rays of light injected by the injection element 120 are received. In other words, the further the microstructures 113 are away from the first edge 114, the more densely they are grouped. Such a distribution advantageously makes it possible to ensure a homogeneous distribution along the axis X of the luminous intensity of the pattern emitted by the flexible guide sheet 110.

The flexible guide sheet 110 may further comprise one or two optional protective layers 112.1 and 112.2 able to afford the flexible film 111 mechanical protection. Furthermore, at least one of the protective layers 112.1 and 112.2 may comprise an anti-UV treatment able to protect the flexible film against UV rays once the microstructures 113 have been etched. Without such UV protection, the pattern projected by the flexible guide sheet 110 is liable to degrade over time, notably when exposed to the rays of the sun.

The flexible film 111 and the protective layers 112.1 and 112.2 are depicted in FIG. 1 as being spaced apart, this being purely illustrative. However, it will be appreciated that the protective layers 112.1 and 112.2 may be intimately associated with the flexible film, notably by being laminated thereto.

Because the guide sheet 110 is flexible, it is not necessarily comprised in a plane but may be curved, according to the position in which it is placed and the mechanical stresses applied to it.

The part of the luminous module 100 that has been illustrated in FIG. 1 also comprises a light-injection element 120, also referred to as a lighting strip as it extends longitudinally in a direction Y, which is able to inject light in a direction normal to its longitudinal direction, for example along the axis X when it is arranged in the way depicted in FIG. 1.

In FIG. 1, the light-injection element 120 is of rectangular or square cross section. However, the light-injection element 120 may have a round, oval or polygonal cross section.

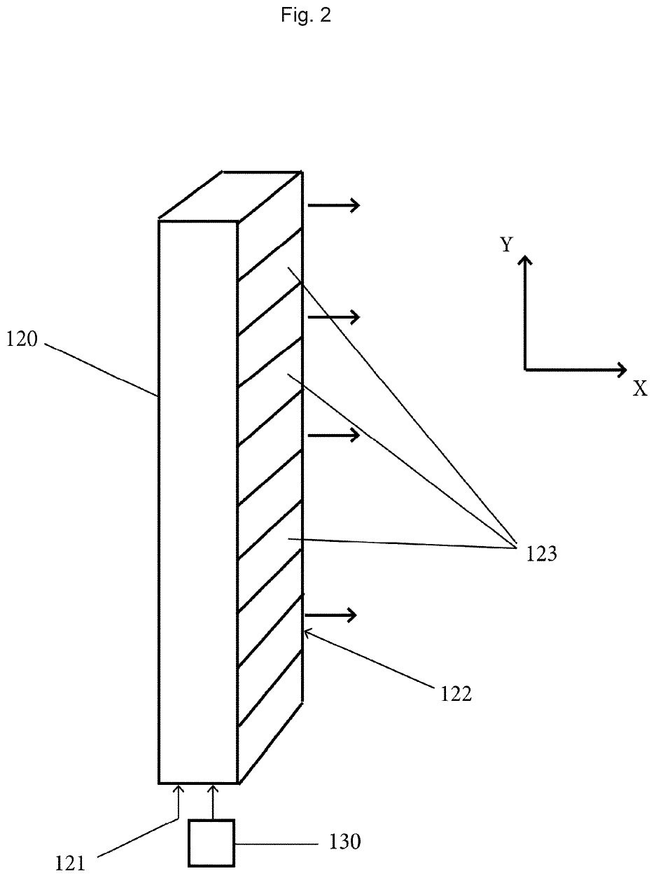

Thus, the light-injection element 120 comprises an exit surface 122 extending in the longitudinal direction and able to inject light in a direction substantially normal to the exit surface 122. The light-injection element 120 further comprises an entry surface 121, at one end of the light-injection element 120, able to receive rays of light from a light source 130, and the light-injection element 120 is able to guide the light longitudinally along the axis Y, distributing it over the exit surface 122. The distribution of light by the exit surface 122 will be more readily understood in the light of the description of FIG. 2.

There is no restriction associated with the light source 130. It may for example be an electroluminescent source of LED type for example, offering the advantage of small size, low energy consumption and only a small degree of heating. The light source 130 may be able to generate light in a range of wavelengths. Such a range may be centered around a visible color, so as to generate colored light, for example blue, red or green. As an alternative, the light source 130 may emit rays of light across the entire range of wavelengths visible to the human eye, so as to generate white light. A very narrow range of wavelengths may be produced by a light source 130 of laser type.

As an alternative, the light source 130 is not positioned directly facing the entry surface 121 of the injection element 120 but the luminous module 100 further comprises an optical fiber placed between the source 130 and the injection element 120, so that the source 130 can be sited remotely in relation to the assembly formed by the injection element 120 and the flexible guide sheet 110.

FIG. 2 shows an injection element 120 of a luminous module 100 according to one embodiment of the invention.

The injection element 120 may comprise a plurality of injection guides 123 able to receive light from the source 130, via the entry surface 121, and to guide the light as far as a longitudinal position on the exit surface 122, the longitudinal positions of the light guides being distinct from one another so that the light is distributed to at least several longitudinal positions on the exit surface 122.

Thus, it becomes possible to inject light at different longitudinal positions along the axis Y of the first edge 114. Each longitudinal position on the first edge 114 may correspond to a guide line of the flexible film 111, able to guide the light along the axis X along such a guide line.

Such a combination of a flexible guide sheet 110, of an injection element 120 and of a source 130 therefore enables light to be projected in the direction Z by a surface that is flexible, transparent, semi-transparent or opaque, with a good surface homogeneity and according to a given pattern.

In practice, such a luminous module may make it possible to emit a pattern with a brightness comprised between 100 and 1000 Candela per square meter, with a light extraction efficiency comprised able to vary between 25% and 80%.

Details regarding the structure and arrangement of the elements 110, 120 and 130 are described further in the international patent application published under the number WO2011130715A2.

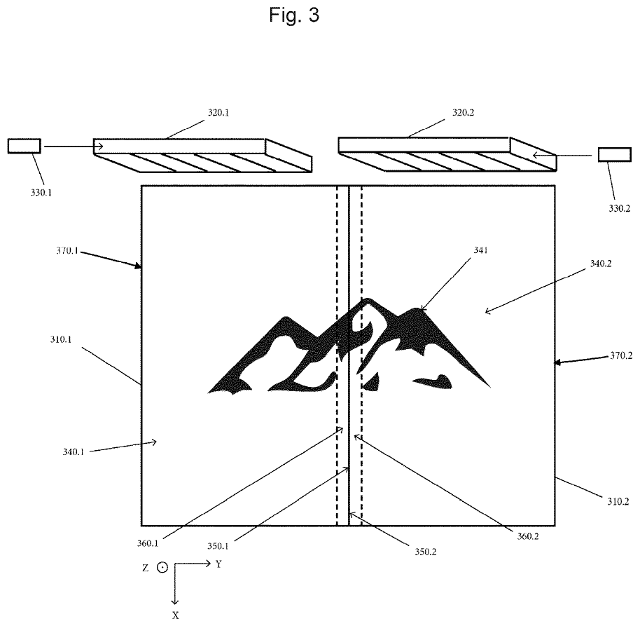

FIG. 3 shows a face-on view of a luminous module 300 according to the invention.

The luminous module 300 according to the invention comprises:
an assembly of at least two flexible guide sheets, comprising a first flexible guide sheet 310.1 and a second flexible guide sheet 310.2 which is similar to the flexible guide sheet 110 illustrated in FIG. 1;
at least a first light-injection element 320.1 and a second light-injection element 320.2 which are respectively associated with the first and second flexible guide sheets 310.1 and 310.2, each light-injection element being able to be the injection element 120 described with reference to FIGS. 1 and 2; and
at least one light source such as the light source 130 described previously with reference to FIG. 1, able to inject light selectively into the first and second injection elements. FIG. 3 depicts, by way of illustration, an embodiment with a first light source 330.1 placed facing the entry surface of the first injection element 320.1, and a second light source 330.2 placed facing the entry surface of the second injection element 320.2.

The first injection element 320.1 is able to inject light originating from the first light source 330.1 into a first edge, such as the edge 114 described previously, of the first flexible guide sheet 320.1.

The second injection element 320.2 is able to inject light originating from the second light source 330.2 into a first edge, such as the edge 114 described previously, of the second flexible guide sheet 320.2.

In the luminous module 300 according to the invention, the first flexible guide sheet 310.1 and the second flexible guide sheet 310.2 are arranged one beside the other in such a way that a second edge 350.1 of the first flexible guide sheet 310.1 faces a second edge 350.2 of the second flexible guide sheet 320.2.

The first flexible guide sheet 310.1 is etched according to a first pattern 340.1 and the second flexible guide sheet 340.2 is etched according to a second pattern. As depicted in FIG. 1, the first and second patterns 340.1 and 340.2 may together form at least one symbol 341. Alternatively, each pattern of a flexible guide sheet may form a symbol independently of the other flexible guide sheets, or may form no symbol, which is the case when the pattern is a spatial modulation of the emitted light with no apparent shape or symbol.

In what follows, the example of two patterns that together form a symbol 341 is considered, purely by way of illustration. The symbol 341 thus corresponds to a luminous zone in the first flexible guide sheet and to a complementing luminous zone in the second flexible guide sheet.

There is no restriction on the number of flexible guide sheets that the luminous module according to the invention comprises. The luminous module may notably comprise more than three flexible guide sheets, arranged in a line or in an array made up of at least two rows and at least two columns. In that case, at least one of the flexible guide sheets has two second edges facing second edges of two other flexible guide sheets.

Thus, the term “second edge” of a flexible guide sheet is used to describe any edge of the flexible guide sheet that faces, or adjoins, another second edge of another flexible guide sheet. One example in which each flexible guide sheet comprises just one second edge is shown in FIG. 3 purely by way of illustration.

A part 360.1 of the first flexible guide sheet 310.1 extends along the second edge 350.1 of the first flexible guide sheet 310.1.

A part 360.2 of the second flexible guide sheet 310.2 extends along the second edge 350.2 of the second flexible guide sheet 310.2.

There is no restriction on the width of the part 360.1 which may be a fraction of a dimension of the first flexible guide sheet 310.1 just as the part 360.2 may be a fraction of a dimension of the second flexible guide sheet 310.2. The part 360.1 may for example represent less than one tenth of the width, or dimension along the axis Y, of the first flexible guide sheet 310.1. The part 360.2 may likewise represent less than one tenth of the width, or dimension along the axis Y, of the second flexible guide sheet 310.2.

The first and second flexible guide sheets 310.1 and 310.2 may have the same shape and the same dimensions.

For example, the first and second flexible guide sheets 310.1 and 310.2 may be rectangular or square in shape. The first and second flexible guide sheets 310.1 and 310.2 may have dimensions along the axes X and Y along which they extend, of between 3 and 25 cm.

What is meant by a “pattern” is any predefined spatial distribution of the luminous intensity emitted by the luminous module. In particular, reference is made here to a two-dimensional or one-dimensional pattern. A pattern may thus be a two-dimensional shape or symbol obtained as a result of the contrast between the luminous intensities at different positions in the plane X-Y of the flexible guide sheet 110. The pattern may also comprise several shapes or symbols. Alternatively, a pattern covers a predefined or deliberate spatial distribution of the luminous intensity that does not reveal a general shape, such as a distribution that gives rise to a cloud of luminous points. In the context of the present invention, a pattern is formed by the injection of light into an injection element which is positioned relative to a flexible guide sheet in such a way as to form the pattern on the flexible guide sheet.

Each flexible guide sheet may optionally comprise at least a third edge, which is an edge distinct from the first edge receiving the light and distinct from a second edge adjoining another flexible guide sheet. The first flexible guide sheet 310.1 may comprise such a third edge 370.1 and the second flexible guide sheet 310.2 may comprise such a third edge 370.2.

The features of the luminous module 300 that have been presented with reference to FIG. 3 apply to the two embodiments described hereinafter.

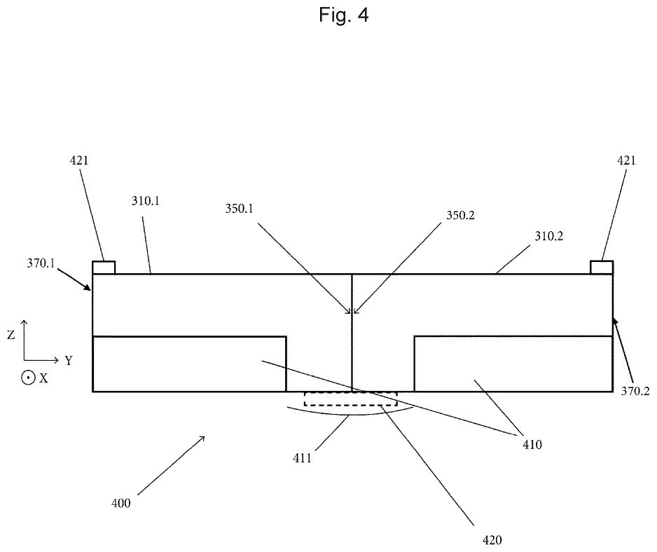

FIG. 4 shows a cross-sectional view of a luminous module 400 according to a first embodiment of the invention.

The cross section depicted is in the plane Y-Z. The luminous module 400 delimits an outer half-space, situated above the luminous module 400, and an inner half-space, situated below the luminous module 400. There is no limitation associated with the adjectives “outer” and “inner”, which are relative, and enable the half-spaces to be named.

In the first embodiment, the parts 360.1 and 360.2 extending along the second edges 350.1 and 350.2 are bent toward the inner half-space defined by the luminous module 400.

This then avoids projecting a line of light in the junction zone situated between the parts 360.1 and 360.2. Thus, it becomes possible to create a luminous module with a large emission surface, because it comprises several flexible guide sheets, without degrading the quality of the patterns projected.

Such a first embodiment is particularly advantageous when the patterns created by the flexible guide sheets together form a pattern or a symbol, as is the case in FIG. 3. The first embodiment thus makes it possible to create such a pattern without an unwanted line or strip of light degrading the visual appearance of the pattern or symbol 341.

Optionally, the luminous module 400 may comprise a support 410 arranged in the inner half-space and able to hold the first and second flexible guide sheets. The support 410 comprises a cavity 411 shaped to be able to accommodate the bent part 360.1 of the first flexible guide sheet and the bent part 360.2 of the second flexible guide sheet. It will be appreciated that the cavity 411 extends along the axis X along the second edges 350.1 and 350.2.

When the luminous module 400 comprises an array of flexible guide sheets, the cavities 411 may form a grating in the support 410. There is no restriction on the means of attachment between the support 410 and the flexible guide sheets, which may comprise mechanical means involving clamping or clip-fastening, or alternatively means of attachment involving adhesive bonding.

The support 410 is able to support and give shape to the flexible guide sheets 310.1 and 310.2. The support 410 may have a planar surface for contact with the flexible guide sheets or, on the other hand, may have a surface that is non-planar, with bumps or angles.

In addition to this, and optionally, the parts 360.1 and 360.2 may be partially or partly covered with a reflective material 420, which covers one surface of the parts 360.1 and 360.2, which surface faces toward the inner half-space, namely downward in FIG. 4. The reflective material 420 may, for example, be a reflective paint. Such an embodiment is advantageous for reflecting the rays of light into the flexible guide sheet so as to illuminate each flexible guide sheet according to the pattern. The light output of the luminous module 400 is thus improved. Thus, a strip of material 420 extends over the junction zone joining the two parts 360.1 and 360.2 on that surface that faces toward the inner half-space, namely on the opposite side from the surface on which the patterns are projected, thereby making it possible not to degrade the patterns projected.

Furthermore, and optionally, a reflective material 421, identical to the reflective material 420, may at least partially cover part of each flexible guide sheet extending along the third edges 370.1 and 370.2. Edge effects at the third edges, which are ends of the luminous module, are thus avoided.

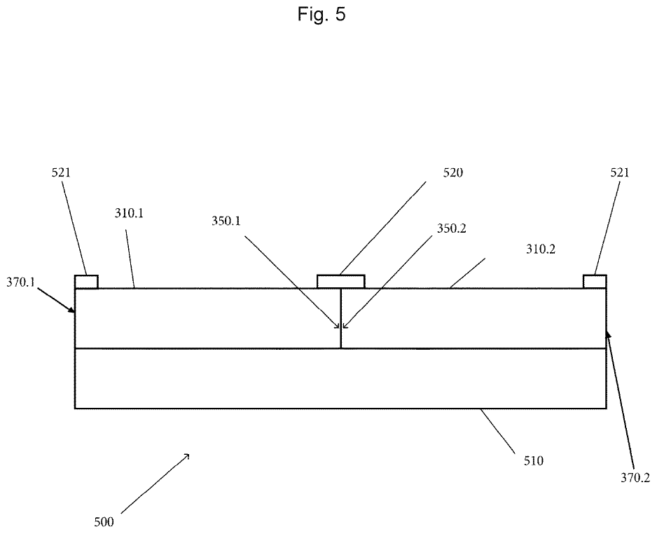

FIG. 5 shows a cross-sectional view of a luminous module 500 according to a second embodiment of the invention.

In the second embodiment, the parts 360.1 and 360.2 of the flexible guide sheets 310.1 and 310.2 are not bent.

In order to prevent the rays of light guided in the flexible guide sheets from forming a luminous strip along the second edges 350.1 and 350.2, a reflective material 520 at least partially covers the aforementioned parts 360.1 and 360.2 on a surface facing toward the outer half-space of the luminous module, namely facing upward in FIG. 5.

There is no restriction on the reflective material 520 which may, for example, be a reflective paint.

The luminous module 500 may also comprise a support 510 which, unlike the aforementioned support 410, does not have to comprise a cavity 411, making such a support 510 easier to manufacture.

There is no restriction on the means of attachment between the support 410 and the flexible guide sheets, which may comprise mechanical means involving clamping or clip-fastening, or alternatively means of attachment involving adhesive bonding.

The support 510 is able to support and give shape to the flexible guide sheets 310.1 and 310.2. The support 510 may have a planar surface for contact with the flexible guide sheets or, on the other hand, may have a surface that is non-planar, with bumps or angles.

The strip of material 520 may be interrupted in the luminous zones of the patterns 340.1 and 340.2, notably when a symbol, such as the symbol 341, falls partially in the junction zone joining the two flexible guide sheets. Consequently, the strip of material does not conceal the symbol 341.

Furthermore, and optionally, a reflective material 521, identical to the reflective material 520, may at least partially cover part of each flexible guide sheet extending along the third edges 370.1 and 370.2. Edge effects at the third edges, which are ends of the luminous module, are thus avoided.

The present invention is not restricted to the forms of embodiment described hereinabove by way of example; it extends to other alternatives.

What is claimed is:

1. A luminous module comprising:
an assembly of at least two flexible guide sheets, including a first flexible guide sheet and a second flexible guide sheet, each flexible guide sheet of the assembly being able to receive rays of light via at least a first edge of the flexible guide sheet and to reflect the rays of light in a direction substantially normal to a surface of the flexible guide sheet according to at least one pattern etched in the flexible guide sheet;
at least a first light-injection element able to receive light and to distribute the light in the first flexible guide sheet and a second light-injection element able to receive light and to distribute the light in the second flexible guide sheet;
at least one light source able to inject light into the first light-injection element and into the second light-injection element;
wherein the first flexible guide sheet and the second flexible guide sheet are arranged one beside the other in such a way that a second edge of the first flexible guide sheet faces a second edge of the second flexible guide sheet;
wherein the first flexible guide sheet and the second flexible guide sheet delimit an outer half-space toward which the light rays are emitted in the direction substantially normal to the surface of the flexible guide sheets, and an inner half-space of the luminous module, complementing the outer half-space; and
wherein part of the first flexible guide sheet extending along the second edge, and part of the second flexible guide sheet extending along the second edge are bent toward the inner half-space or are at least partially covered with a reflective material.

2. The luminous module as claimed in claim 1, further comprising a support arranged in the inner half-space and able to hold the assembly of at least two flexible guide sheets, the support including a cavity able to accommodate the bent part of the first flexible guide sheet and the bent part of the second flexible guide sheet.

3. The luminous module as claimed in claim 1, wherein the part of the first flexible guide sheet extending along the second edge and the part of the second flexible guide sheet extending along the second edge are bent toward the inner half-space and the reflective material at least partially covers a surface of the bent parts that faces toward the inner half-space.

4. The luminous module as claimed in claim 1, wherein the reflective material at least partially covers a surface facing toward the outer half-space of the part of the first flexible guide sheet extending along the second edge and of the part of the second flexible guide sheet extending along the second edge.

5. The luminous module as claimed in claim 1, wherein the reflective material is a reflective paint.

6. The luminous module as claimed in claim 1, wherein the reflective material is a strip extending along the second edges of the first and second flexible guide sheets.

7. The luminous module as claimed in claim 1, wherein the first flexible guide sheet is etched in such a way as to project a first pattern when the at least one light source injects light into the first injection element, and the second flexible guide sheet is etched in such a way as to project a second pattern when the at least one light source injects light into the second injection element, wherein the first and second patterns arranged one beside the other together form at least one luminous symbol.

8. The luminous module as claimed in claim 7, wherein the strip of reflective material is interrupted over the luminous symbol.

9. The luminous module as claimed in claim 1, wherein at least one of the flexible guide sheets includes a third edge distinct from the first and second edges, wherein at least part of the flexible guide sheet extending along the third edge is covered with a reflective material on a surface facing toward the outer half-space.

10. The luminous module as claimed in claim 1, wherein the assembly includes more than two flexible guide sheets placed one beside the other in such a way as to form an array of flexible guide sheets.

11. The luminous module as claimed in claim 1, wherein one dimension of the flexible guide sheets is between 3 and 25 cm.

12. The luminous module as claimed in claim 1, wherein each flexible guide sheet of the assembly has a thickness between 0.2 and 1 mm.

13. The module as claimed in claim 1, wherein each flexible guide sheet includes a film including microstructures, wherein each pattern from among the first and second patterns is etched by ultraviolet printing of the microstructures of the film. 14. The module as claimed in claim 13, wherein, for each flexible guide sheet, the surface density of microstructures decreases with distance from the edge of the guide sheet into which the light is injected.
